(19) United States
(12) Patent Application Publication
(10) Pub. No.: US 2017/0190488 A1
(43) Pub. Date: Jul. 6, 2017

(54) A CONTAINER CARRIER

(71) Applicant: British Polythene Limited, London (GB)

(72) Inventor: Stephen Paul Bates, Reading (GB)

(21) Appl. No.: 15/315,682

(22) PCT Filed: Jun. 2, 2015
(86) PCT No.: PCT/GB2015/051606

§ 371 Date: Dec. 1, 2016

(30) Foreign Application Priority Data
Jul. 3, 2014 (GB) 1411919.2

(51) Int. Cl. B65D 71/50; B32B 38/00; B32B 27/32; B32B 37/20; B32B 3/26; B32B 27/08; B65B 17/02; B32B 37/10

(52) U.S. Cl. CPC B65D 71/504; B65B 17/025; B32B 38/0004; B32B 37/10; B32B 37/203; B32B 3/266; B32B 27/08; B32B 27/32

(57) ABSTRACT

An apertured plastics film (100,110) for holding containers together to form a unitised carrier package, includes apertures (101) for respectively holding a single container wherein internal edge portions of each aperture form tab elements (102-105) for contacting the container when positioned within an aperture, and engaging with a beading of the container, and has a plastics cover sheet (120) applied to the apertured plastics film (100,110) and covering the apertures, wherein the plastics cover sheet (120) is attached to the apertured plastics film at least at edge portions of the apertured plastics film or edges of the apertures, and wherein a portion of the cover material (120) is deformed locally at each aperture to effect localised expansion by a former (146,151) before the apertured plastics film is applied to the containers.

### FIELD OF THE INVENTION

The present disclosure relates to a plastics carrier for “primary packaging”-containers and to packaging systems for such containers whereby multiple containers can be “unitised” for handling and transport purposes. In particular, the present disclosure relates to plastics film packaging useful for securely retaining containers for consumable produce. The containers may include, without limitation, drinks cans, food cans, bottles, jars and similar containers having a chime, neck ridge or seal beading. The disclosure further relates to a method of applying the plastic film packaging as a unique form of “secondary packaging” to group or “unitise” the containers, and to the resultant “unitised” combination. The disclosed plastics carrier is useful for packaging multiples of identical containers such as beverage cans having annular chimes, cylindrical side walls, and frusto-conical walls between the chimes and the side walls, and bottles with a neck ridge or seal beading.

### BACKGROUND TO THE INVENTION

It is common practice to package beverages such as sparkling fruit juices, soft drinks, beers, ciders and the like, or sparkling water in bottles or cans. A “can” as typically used in the industry is manufactured from pressed aluminium or plated steel, the thickness being of the order of 50 μm or so. The size of the can varies depending upon market preferences and traditions.

A traditional baked-bean can may be sized 307×512 US CMI. A “can” as typically produced in the beverage industry in Europe is one of the following types (all sizes are approximate) 330 ml, 66 mm Ø/115 mm height; 440 ml, 66 mm Ø/150 mm height; 500 ml (˜16 fluid ounces US) 65 mm Ø/170 mm height. Another 250 ml can size which has been introduced for specialist beverages such as the so-called “energy” drinks is also slightly necked and is about 52 mm Ø/135 mm height. The subject of this disclosure is applicable to all such cans without limitation thereto.

These cans are typically sold in four-or six-packs. Early examples of packaging such packs utilised cardboard which enveloped the cans. In the 1950's plastic film container carriers were first promulgated. The early forms of plastics film container carrier utilised apertures which were deformed upon application of the sheet over the cans, whereby the film formed a continuous flange area about the side of the can. The films were placed about the top of the can, underneath a beaded edge formed at the junction of the lid of the can. Such early forms of carrier film allowed the cans to be pulled through—albeit with some difficulty—but a reverse movement of the can with respect to the carrier would mean that the plastics flange would abut the bead and further movement required a considerable force to release the can. Shrink sleeve wrapping surrounding multiple items represents a different form of outer secondary packaging and is typically used for handling and delivery to a retail outlet where the secondary packaging is removed before the consumer purchases one or more of the separated items. A key difference in this type of package is that once the shrink wrap is cut or damaged, the integrity of the shrink wrap multiple item package may be compromised because each item is not individually held in the secondary packaging.

Examples of packaging proposed for containers, especially “cans”, can be found in the following references which may be useful in understanding the background to this disclosure: GB1200807, U.S. Pat. No. 2,874,835, U.S. Pat. No. 2,936,070, U.S. Pat. No. 2,997,169, U.S. Pat. No. 3,317,234, U.S. Pat. No. 3,924,738, U.S. Pat. No. 3,968,621, U.S. Pat. No. 4,219,117, U.S. Pat. No. 4,250,682, EP0461748, EP0621203 and EP1038791.

### SUMMARY OF THE DISCLOSURE

The present disclosure relates to developments in thin plastics material useful for forming a carrier (carrier stock) for grouping multiple items, as unitised packages. Unitised packages permit a user to selectively remove one or more items from the unitized package, leaving the remaining items securely held in the unitised package. In particular the thin plastics material disclosed herein has engineered apertures for retaining items in a particular manner which apertures are covered with a cover material before and after the thin plastics material is applied to multiple items for unitising purposes. The cover material for the apertures is flexible and does not prevent positioning of the apertures over respective items to be unitised by the method disclosed herein.

The cover material for the apertures may be in sheet form, for example fed from a reeled web of plastics film of appropriate thickness and width dimension and overlaid upon the apertured plastics film. The cover material is attached to the apertured plastics film. The presently disclosed covered apertured plastics carrier would not be applied using traditional methods typically used in the industry which require use of jaws or fingers insertable into respective apertures to apply stretch allowing the known carrier stock to be fitted over the cans to be unitised. Accordingly the present disclosure also relates to a method of packaging items using a covered apertured plastics carrier, characterised by a roller application step requiring no use of jaws or fingers to be inserted into an aperture.

In an embodiment of a manufacturing method, carrier stock of plastics film is fed to a cutting station where an apertured profile is formed and subsequently the apertured plastics film is presented for receiving a cover material which is applied to, for example overlaid upon, the apertured plastics film and attached thereto to form a covered apertured plastics film. The cutting station may be operatively associated with, or part of the packaging machinery and part of a packaging line.

Optionally the cover material attached to the apertured plastics is contacted with a former capable of locally expanding the cover material, so as to form an indented pouch, pocket, bulge or “bubble” shape in the cover material at each aperture in the apertured plastics film. One method of achieving this is to contact the cover sheet with the former and provide for relative movement of the former with respect to an aperture of the apertured plastics film in a controlled manner. Thus the covered apertured plastics film may be pressed upon the former which enters an aperture, but does not contact the aperture edges, and in that way the former contacts and expands the cover material. A roller may be adapted to the purpose. A roller suitable for this purpose may have multiple spaced formers positioned to respectively coincide with and penetrate apertures in the apertured plastics film when a portion of the covered apertured plastics film is received upon the roller. Optionally the covered apertured plastics film is passed between a pair of cooperating rollers one of which has a male former, and the other has a corresponding recess or female former.

In an embodiment of a packaging method, a plurality of items are delivered to a unitising packaging machine, collected and arranged to receive a covered apertured plastics film in a unitising operation. A carrier stock of plastics film is fed to a cutting station where the required apertured profile is formed in the plastic film to provide an apertured plastics film, and subsequently the apertured plastics film is presented for receiving a cover material which is applied to the apertured plastics film and attached thereto to form the covered apertured plastics film. The covered apertured plastics film is presented to a device including a former for locally expanding a portion of the cover material associated with an aperture to form an indented pouch, pocket, bulge or “bubble” shape in the cover material covering the aperture. The cover material may be a plastics film or laminate. The cover material may be significantly thinner than the apertured plastics film.

According to an aspect, a plastics film carrier for unitising items comprises (i) a plastics film wherein apertures are arranged for receiving and holding items, and (ii) a plastics cover sheet applied to the apertured plastics film and covering the apertures, wherein the plastics cover sheet is attached to the apertured plastics film at least at edge portions of the apertured plastics film.

Apertures can be formed by cutting the plastics film.

The plastics film may comprises a plurality of apertures, each one of the plurality of apertures being defined between internal edge portions of the plastics film, each edge portion forming a tab for contacting an item when the item is positioned within an aperture.

The plastics cover sheet may be applied to a surface of an apertured plastics film as an overlay which lays flat upon the apertured plastics film.

The plastics cover sheet may be applied as overlay to a surface of the apertured plastics film immediately after the apertures in the plastics film have been formed.

The plastics cover sheet may extend beyond covering the apertures to cover the full surface width of the apertured plastics film.

The plastics cover sheet may be attached at peripheral surfaces of the apertured plastics film.

The plastics cover sheet may be attached at edges of the apertured plastics film.

The plastics cover sheet may be attached at edges of the respective apertures of the apertured plastics film.

The plastics cover sheet may be attached to the apertured plastics film by bonding and/or by pressure. Bonding may be realized by use of heat alone, hot seal or heat curable adhesive optionally with applied pressure. Bonding may achieved by applying an adhesive which may be any suitable contact adhesive, glue, or plastics bonding agent that is capable of attaching the plastics cover sheet to the apertured plastics film sufficiently that separation one from the other in a subsequent item-unitising operation is unlikely. Combinations of such bonding techniques may be used.

The plastics cover sheet may be formed from a plastics film or formed as a laminated plastics sheet.

The plastics cover sheet may be of a plastics material which is expandable.

The plastics cover sheet may be one that is resistant to tearing or perforating.

The plastics cover sheet may be a laminated sheet of one or more polyolefin blend plastics.

The plastics cover sheet may be a laminated sheet of polythene.

The plastics cover sheet may be thinner than the apertured plastics film.

The thickness of the plastics cover sheet may be at least about 10 microns.

A plastics cover sheet having a thickness of up to about 50 microns may be sufficient for the purposes of covering the apertures of the apertured plastics film, and remaining intact during application in a unitising operation and thereafter. However, a thickness greater than 50 microns may be used.

Optionally, a range of thickness (TC₁-TCₙ) of the plastics cover sheet, and a range of thickness (TF₁-TFₙ) of the apertured plastics film may be considered together, to select values (TCₙ+TFₙ) such that each thickness is selected to provide an overall thickness with the aim that together the overall strength of the covered apertured plastics film provides an adequate unitising carrier strength. This option provides greater flexibility in use of available materials.

The plastics cover sheet may be pre-expanded prior to application of the plastics film carrier to multiple items in a unitising operation. The pre-expanding step may be achieved by presenting a former against the plastics cover sheet, and applying sufficient force to achieve a localised expansion of the plastics cover sheet around the former. A suitable former is of lesser width dimensions than an aperture of the apertured plastics film so that movement of the former through an aperture of the apertured plastics film does not disturb the shape and size of the aperture of the apertured plastics film. The expanded part of the plastics cover sheet may resemble a partially collapsed bubble in the cover sheet after the former is removed therefrom.

The former may be provided upon a part of a mechanism for feeding covered plastics film carrier to an item unitising apparatus, which may form part of packaging machinery or a packaging line. For example the former may be provided upon a roller contacted by the covered plastics film carrier during transit to an item unitising apparatus. The roller may be one of multiple cooperating rollers through which the covered plastics film carrier passes. One such roller of the multiple cooperating rollers may have a male former, and another such roller may have an aperture or recessed female former for receiving at least a part of the male former. A pair of rollers may be used to form the cover of the covered plastics film carrier in the aforesaid pre-expanded form. The covered plastics film carrier may be passed over a roller including at least one male former for pre-expanding the cover of the covered apertured plastics film carrier before the covered apertured plastics film carrier is applied to items in a unitising operation.

The plastics cover sheet may be colourless or coloured.

The apertured plastics film carrier may be formed from carrier stock as disclosed in GB 2 475 622 B and GB 2 485 895 B.

A suitable carrier stock for unitising multiple items comprises a thin plastics film wherein a plurality of apertures are provided for respectively holding an item, each one of the plurality of apertures being defined between internal edge portions, each edge portion forming a tab for contacting an item when the item is positioned within the aperture, and a cover film overlying the thin plastics film and attached thereto. Where the item is a can, or bottle, which has a beading around an upper part thereof, each edge portion tab may engage with said beading to hold the can or bottle within the aperture. The holding of the can or bottle within the aperture can be overcome by application of sufficient force to separate the can or bottle from the carrier stock.

GB 2 475 622 B and GB 2 485 895 B relate to aspects of item packaging and disclose plastics film carriers and unitising machinery. In particular these disclosures describe the characteristics of the engineered apertured thin plastics film material enabling superior unitising properties to be realized. The disclosures thereof are incorporated herein by reference.

In the disclosures of GB 2 475 622 B and GB 2 485 895 B carrier stock is described, which is provided with a number of apertures for holding a number of containers together, the stock comprising a thin plastics sheet material having a number of apertures arranged in at least a first direction, wherein the apertures have a centre and wherein the edges defining the apertures have a geometry which comprises a plurality of tabs facing the centre, the tabs being separated by troughs, the troughs comprising a root at a maximum point from the centre; wherein the innermost edges of the tab elements and the roots lie, respectively, on first and second circumferences relative to the centre, the second circumference being equal to or greater than the circumference of a container; the configuration of the apertures being such that, upon placement about a container, the edges of the tabs engage with said beading of such a container as the plastics sheet material is urged downwardly and outwardly and the thin plastic sheet material elastically forms a three dimensional structure. The same carrier stock can be used to form the covered plastics film carrier subject of the present disclosure.

As disclosed in GB 2 475 622 B and GB 2 485 895 B, where the tabs meet with the underside of a beading of a container, such as the chime of a beverage can, the thin plastics sheet material of the carrier is deflected in a downwards direction. The contact with the container is discontinuous and the application of the thin plastics sheet material creates a three dimensional wave like configuration in the thin plastics sheet material which acts against the tabs or fingers and forces them to remain in contact with the containers. At the corners of the sheet (in the case of a four pack for example) opposite where the cut outs in the aperture are situated, because there are no downward forces, only lateral ones exerted by the effect of the tabs acting against the chimes, the material is forced into an apex at its furthest point from the can contributing to the wave effect. This combination of wave effect and apex further prevents the tabs from moving away from the underside of the chime and ensures the containers are held securely.

The film suitable for use here in providing an apertured plastics film is conveniently manufactured from relatively thin plastics, such as for example 100-300 μm thickness plastics, which plastics can be selected from the group comprising polyethylene, polyethylene derivatives and plastics materials with similar mechanical properties. A wide range of plastics material can be used, since the product is not stretched during application to an extent where any occlusions or similar defects may give rise to subsequent problems, and can be made from recycled plastics such as post-consumer waste (PCW) plastics. In view of the stresses that are applied both in the traditional fitting of the plastics film stock by machines and in subsequent use and transportation, previous systems always employed good quality plastics: avoiding use of re-cycled plastics materials (post-consumer waste (PCW) material) which may have inclusions within the material whereby the integrity of the stressed plastics sheet is questionable.

The apertured plastics film conveniently has further reduced size apertures within the plastics film between the container-receiving apertures, such further apertures assisting in re-configuration of the apertured plastics film during application to containers to create a wave effect structure in the apertured plastics film, and assisting in the apertures being more simply fastened about a container. Additional apertures may also assist in the manual handling of completed container pack, by providing finger access apertures. Additionally, it should be borne in mind that having an increased number of apertures in the film will mean that the overall cost of material supply is reduced.

The apertured plastics film can be dimensioned to fit around traditional cylindrical walled cans such as a traditional baked-bean can. The apertured plastics film can be dimensioned to fit about the necked-in cans as are typically presently produced in the beverage industry. The apertured plastics film can be dimensioned to fit about the necks of bottles, wherein beading around the neck of a bottle can act in a similar fashion to the chime or beading of a can. The apertures can resemble a generally square-like (quadra-arcuate) aperture, with the tabs comprising slightly outwardly extending arcs. Other poly-arcuate apertures are possible, the number of tabs, however being less than ten, for containers such as are commonly employed for beverages.

The carrier stock or apertured plastics film can comprise integrally joined band segments defining can-receiving apertures in longitudinal rows and transverse ranks. There may be a single longitudinal row. The band segments include generally longitudinal outer segments with each outer segment partly bounding the can receiving apertures in an outer row. In application, the carrier stock or film can be provided as a roll or sheet for use in a roll on method of applying the product, conveniently in a multi-lane format, which in an embodiment may be for example but not exclusively 6 lanes wide. The carrier stock may be is supplied as a sheet or on a roll and feeds into the application machine in a near continuous action, whereupon it is sub-divided within the machine into the required pack sizes, e.g. 4 packs, 6 packs etc. The method of rolling film on to the top of the container uses the downward pressure of the roller as the containers pass beneath it to gently elastically form the material through the interaction of film and container in order to achieve the aforementioned gripping action and 3 dimensional transformation of the sheet material.

In particular, the apertured plastics film after application to a number of containers defines a three dimensional, undulating or “wave” shape as a direct result of the various forces acting upon the material, whereby to increase the inherent strength of the resultant product. As a direct result of the increase in strength of the applied film (in three-dimensions), a reduction in the grade and thickness of the film material can be realised: costs can be reduced because less raw material is required. Further by virtue of the machinery not being required to exert tremendous forces to enable the material to engage with containers, the specification of the packaging plant can be reduced, again reducing costs. A still further advantage is that because the machinery is less massive and can be applied without large mechanical jaws/fingers/hands (as are presently used in the industry—which impede the function of adjacently located mechanical jaws/fingers/hands), several packing streams can be simply placed in side-by-side configuration—even enabling 12-aperture rows to be manufactured.

Specifically, the three-dimensional “wave” form provides a strength far greater than that which would have been achievable with a standard film. As a direct result of its increased strength, the material of choice can be selected for price and availability rather than quality of the flat stock per se.

In most cases the orientation of the covered apertured plastics film during application to the containers does not matter. Embodiments may apply the covered apertured plastics film with the apertured plastics film uppermost with the cover material next to the container, or vice versa. Care need only be taken in certain embodiments where a relatively thick cover material is used, in which case the preference would be to have the cover material uppermost with the apertured plastics film next to the container. This means that it is generally very easy for a packaging machine operator to run the covered apertured plastics film for unitising containers.

The above and other advantages enable improvements over the state of the art to be achieved.

### BRIEF DESCRIPTION OF THE FIGURES

Various embodiments will now be described, by way of example, with reference to the accompanying drawings, in which:

FIG. 1 is a plan view of a portion of a carrier stock providing an apertured plastics film for use in unitising items;

FIG. 2 is a plan view of a “2×2” apertured plastics film suitable for use in unitising items as a “four-pack”;

FIG. 3 is a plan view of an alternative a “2×2” apertured plastics film suitable for use in unitising items as a “four-pack”

FIG. 4 is a plan view of an alternative a “2×2” apertured plastics film suitable for use in unitising items as a “four-pack”;

FIGS. 5a and 5b show, from alternative perspective viewpoints, the contoured form of the apertured plastics film developed when applied to necked-in ring-pull cans;

FIGS. 6a-6g show in plan and in equivalent stage side view application of apertured plastics film to cans by means of a roller;

FIG. 7 shows a side view of a part of a unitising packaging plant where covered apertured plastics film is presented for application to items, and including a plastics cover film expanding device operable prior to unitisation of items;

FIG. 8 is a side view representing overlay of a plastics cover sheet over an apertured plastics film in the production of a covered apertured plastics film; and

FIG. 9 is an enlarged view of the part of FIG. 7 circled in dashed outline, showing a side view of part of a roller handling device having a former for deforming a plastics cover sheet to form an expanded portion of the plastics cover sheet over an aperture in the apertured plastics film.

### DETAILED DESCRIPTION OF EMBODIMENTS

Apertured Plastics Film:

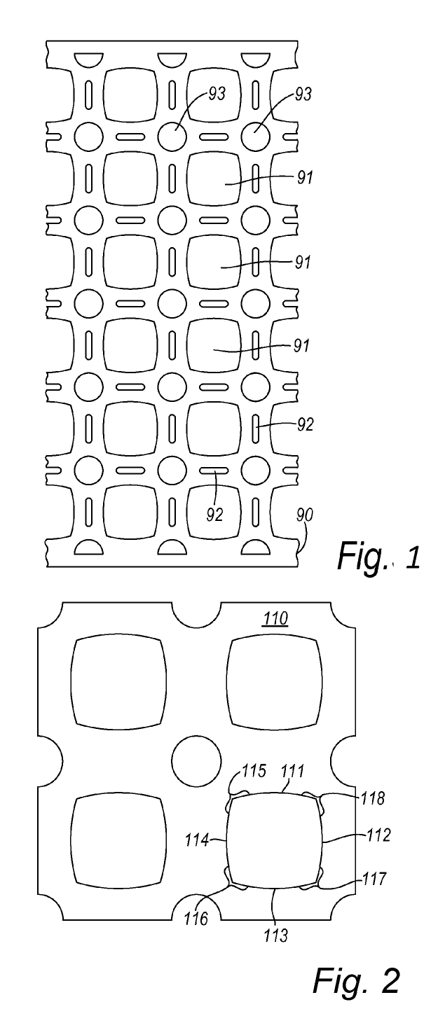

Referring now to FIG. 1, a portion of carrier stock of apertured plastics film 90, with six apertures abreast, is shown as an illustrative example, the apertures 91 being of a regular quadrilateral shape. Further apertures or slits 92, together with circular apertures 93 are sized and positioned to assist in the maintenance of a 3D “monocoque”-film shape, once containers have been retained by the film. The circular opening 93 may be formed of difference shapes or may be replaced by a number of smaller apertures, conveniently closely spaced together. In this apertured plastics film 90 the shape and position of the apertures are such that the troughs between the tabs (fingers) correspond with the corners of the curved sides, the distance between opposite troughs being approximately 110% the diameter of the container at the rim.

FIG. 2 shows a portion of another form of apertured plastics film, wherein each side of a generally square aperture comprises distinct arc sections 111-114; and troughs to be formed in use can be considered to exist at the centre of adjacent arcs 115-118. This portion is suitable for forming a four item unitised package.

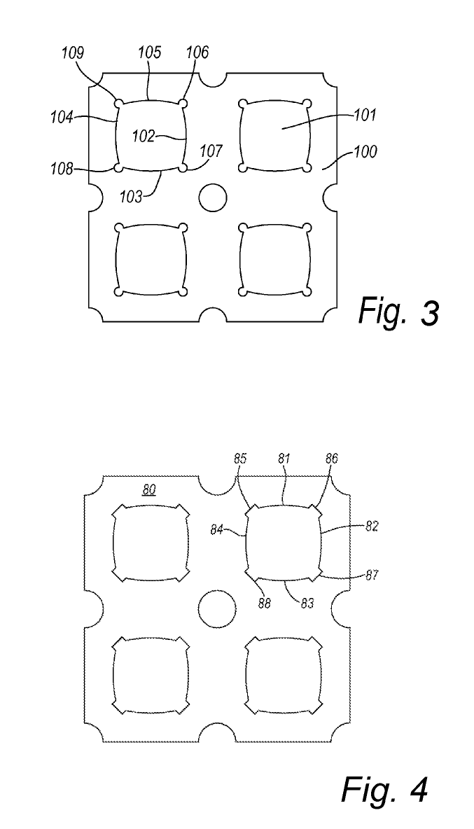

FIG. 3 shows a portion of a further apertured plastics film 100, which has generally square apertures 101, which have fingers 102-105 separated by portions forming small troughs 106-109 (in use). The troughs are more pronounced in comparison with the troughs formed by the apertured plastics film of FIGS. 1 and 2. Other shapes can be used for the portions of the apertured plastics film between the apertures which in use form troughs for example with regard to a requirement not to induce tears in the film. Again the distance between opposite trough portions is approximately 110% the diameter of the container at the rim.

FIG. 4 shows a portion of an apertured plastics film 80 used for unitising items typically containers such as beer cans in plan view in FIG. 4. Each aperture in the apertured plastics film 80 is of a general square shape, operably arranged to accept a circular end of a cylindrical part of a container therethrough, with four fingers or tabs 81, 82, 83 & 84 extending from indentations or troughs 85, 86, 87 & 88 having a web element connecting adjacent tabs. The troughs 85, 86, 87 & 88 lie on a radius slightly greater than the radius of the container about which the film is designed to fit in a retaining manner to hold the container in a unitised package. The edges of the tabs, which are analogous to nails extending from human fingers, i.e. the portions that will abut the rim or chime of the can, are conveniently slightly curved inwardly. Indeed, in order to most closely fit about a container, the arc corresponds to an arc of a circle of a radius corresponding to a radius of the container that lies immediately adjacent the rim or chime of the container, the shape taking into account the fact that the film will adopt an undulating shape in view of the resilience of the plastics film being utilised. It is important to note that whilst the elastic properties of the film are utilised, the elastic limit of the material is not approached.

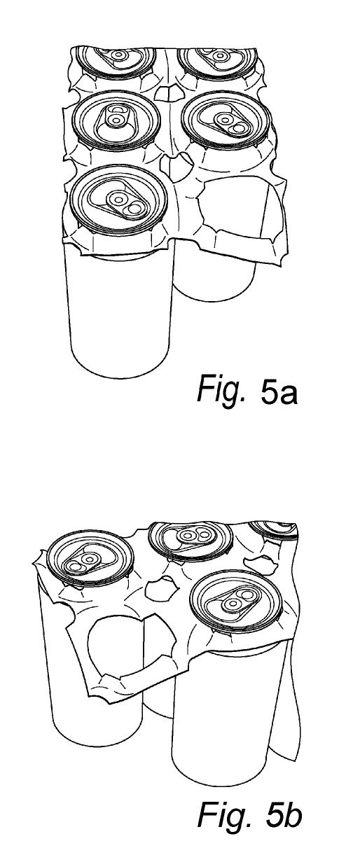

FIGS. 5a and 5b show first and second perspective views of an arrangement of five beer cans retained by an apertured plastics film 80 (carrier stock) having six container apertures.

Covered Carrier

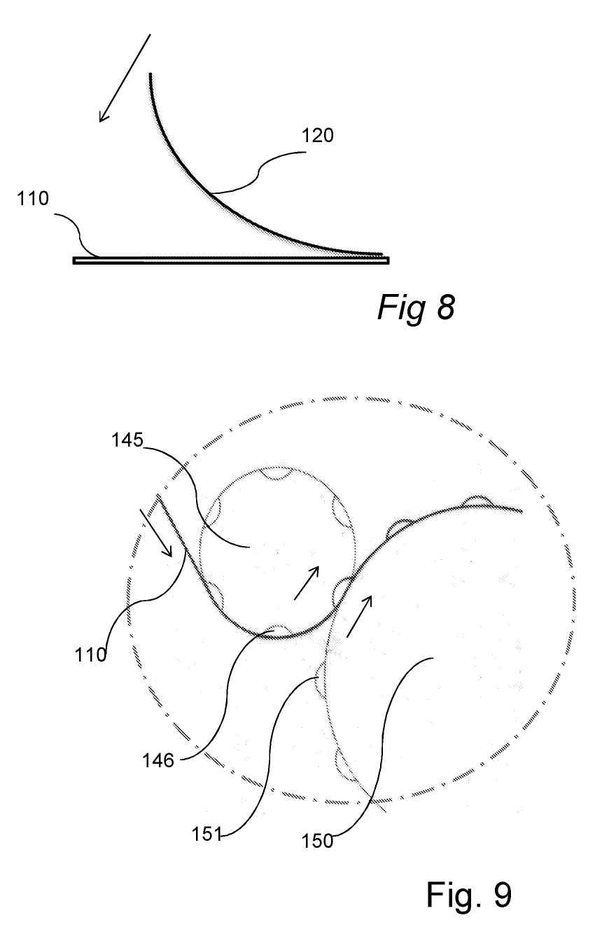

Each of the apertured plastics films illustrated in the accompanying figures may receive an overlay of a plastics cover sheet that is attached to the apertured plastics film so as to cover the apertures. The plastics cover sheet may be a laminate of a polyolefin and is even thinner than the thin apertured plastics film. The appearance of the covered plastics films is not significantly changed, and in plan view is identical to that of any of the aforedescribed apertured plastics films of FIGS. 1-4. FIG. 8 illustrates overlay of a plastics cover sheet upon an apertured plastics film viewed from one side. FIG. 9 illustrates a process step applied only to the cover material of the covered apertured plastics film. In this step a passive former is used to expand a portion of the cover material local to an aperture into an indented pouch, pocket, bulge or “bubble” shape in the cover material over the aperture. This slight modification to the cover material mitigates any potential inhibition of the re-configuration of the apertured plastics film to the wave-form shape during a unitising operation.

Unitising of Items

In use, carrier stock is provided with a number of apertures for holding a number of items, typically containers such as bottles or cans, together to form a unitised package, the stock comprising a thin plastics sheet material having a number of apertures arranged in at least a first direction. The apertures comprise a plurality of tabs (finger elements), separated by troughs, the apertures having a centre. The peaks of the tabs lying on a first circumference relative to the centre whilst the root (bottom-most part) of the troughs (that part of the troughs most distant from the centre of the aperture) lie on a second circumference relative to the centre, the second circumference being equal to or greater than the circumference of the container. A roller device is used to apply the apertured plastics sheet material to collected items arranged for unitisation. In use the peaks of the tabs engage with a beading of a container whilst the troughs, as a direct result—since they are part of the same film—are urged downwardly and outwardly. In so doing the troughs urge the film to elastically form upon placement and enable the film to adopt a three dimensional wave-like structure. Whilst the number of tabs can vary from three upwards, it has been found that a four tabbed aperture benefits in terms of packaging of can-shaped products by reason of the forces from the chime, through the tabs, which allow upward movement of film adjacent the troughs, whereby to create a wave effect in a re-configured apertured plastics film applied over the containers. The three dimensional structure adopted by the film is in many ways analogous to a particularly strong type of structure adopted in motor vehicular manufacturing i.e. the structure known as a monocoque structure where the overall strength of the finished film achievable is greater than that of the inherently flexible material before it is applied in the unitising process.

Referring in particular to FIG. 4, film 80 is provided with apertures 81, the apertures being defined by tabs 82-85. In order to explain the use of the apertured plastics film, by way of illustration only one aperture 81 will now be discussed: the distance between the centres of oppositely facing tabs is approximately 90% of the diameter of the portion of the container about which the aperture will close upon, whilst the distance between opposite troughs corresponds to 110% of said diameter. As can be seen, with further reference to FIGS. 5a and 5b, the tabs 82-85 abut the lower part of the chime or rim of the can and the film closely follows the necked-in portion of the container. Rather than utilising the elasticity of the plastics film material to enable containers to be retained, the apertured plastics film after rolling application over the top of contains adopts a three dimensional “wave-like” geometrical form (as evident in FIGS. 5a and 5b) that enables the shape of the film to thereby provide a relatively rigid arrangement. This configuration adopted upon the containers is so strong that rather than require use of a high quality virgin plastics film of a preferred thickness in the range of 400-500 μm, the apertured plastics film can be formed from recycled plastics film of a thickness of 350 μm or less. It is to be realised that whilst the weight of a single apertured film for a six-pack is of the order of a couple of grammes, globally, several thousands of tons of plastics are employed in the manufacture of container unitising film. A reduction in the amount of plastics by 25% or more will provide a significant reduction in operating costs for any canning plant. Additionally, it is known in the art (for example from EP1038791), that any buckling of a transverse web is to be minimised because of customer perception; a smooth transverse web is believed to be more aesthetically pleasing.

Since recycled materials are more likely to have inclusions and other faults, which can compromise the strength of material that is stretched towards an elastic limit, the industry has previously not been able to accept such materials, increasing the financial burden in the packaging industry.

The procedure for application of the covered apertured plastics film can be conveniently formed by a number of methods. A presently preferred method will be described with reference to an apertured plastics film such as that illustrated in FIG. 4, which, for convenience shall be assumed to be receiving a can, not shown, from the right. For the purposes of discussing the interaction with the can, the presence of a plastics cover sheet applied to and attached to the apertured plastics film can be ignored since the plastics cover sheet has no role in holding the can in the unitised package being formed.

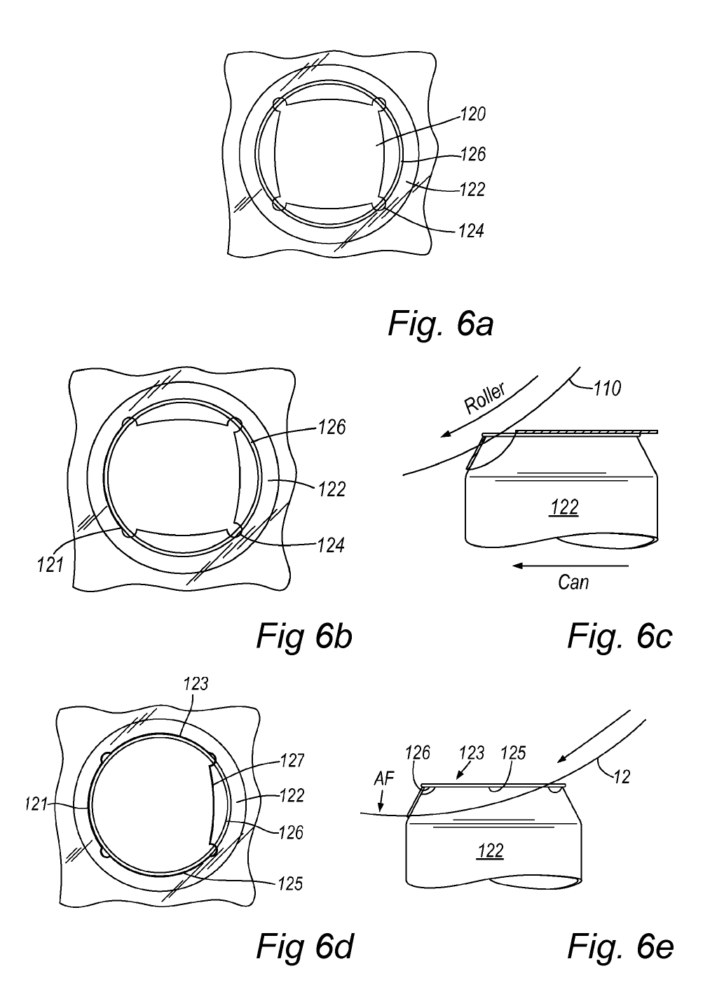

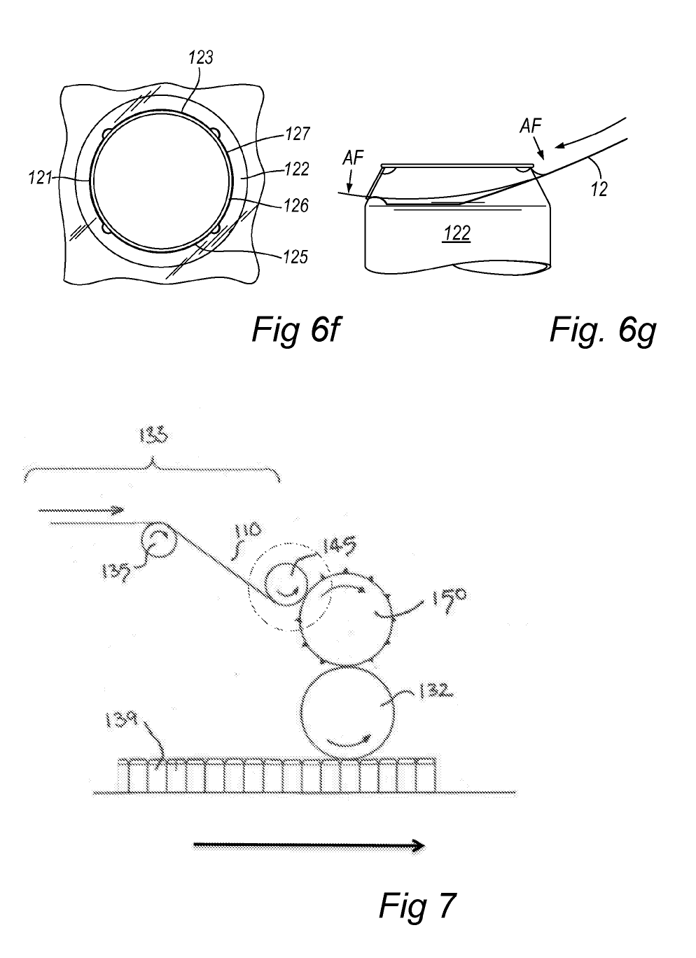

The application of the apertured plastics film to the can is realised by use of a roller device as represented in FIGS. 6a-6g.

The inside edge of 84 of the aperture is urged toward the under-chime (upper rim) of a can; the adjacent sides 81, 83 of the aperture are then eased over the corresponding rim parts of the can until the inside edge of the aperture opposite the first engaged side of the aperture is adjacent the rim, whereupon continuing pressure enables the inside edge of the last aperture 82 to engage with an underside of the rim, thereby enabling the apertured plastics film to simply, safely and securely engaged therewith.

It will be appreciated that since significant forces would not be required to enable the apertures to be placed over containers, then the machinery need not be so massive and that three or more containers may be easily retained by a film; previous systems cannot reliably unitize more than two containers in a process such as a fast moving production line.

Whilst the discussed example is a four sided “square” aperture, it will be appreciated that a generally three fingered aperture may be provided, comprising a generally equilateral triangular configuration, and would provide a minimally fingered design with a security of retention. It will be appreciated that many polygonal forms can be configured which operate in accordance with the disclosed concept, although, a regular four-sided aperture is likely to be more readily generally accepted in the field. The polygonal form of the aperture may be chosen to suit the item to be unitised with other like items in a unitised package.

A preferred method of application utilises a simple roll on application method as shall be disclosed in detail hereinafter; a simple machine can be utilised in manufacturing industry; since great stretching forces are not applied, lever arm and/or hydraulic operations can be minimised and the strength of the machine need not be great, as a direct result compared to systems which stretch plastics towards and beyond their elastic limits. The use of simpler and cheaper machines will also enable the systems to be operated by smaller manufacturing concerns and thereby increase markets.

FIGS. 6a-6g illustrate a superposition of the edges of an un-stretched aperture upon a beading 126 of a container (shown as a can) 122. FIG. 6b shows how, in a first application step associated with retaining a number of such containers with a carrier stock of apertured plastics film, an inside tab edge 121 of the aperture abuts against an underside edge of a bead 126 of the container. FIG. 6c shows how, in relation to an apertured plastics film 110 an application roller will rotate with respect to a container passing underneath in a direction perpendicular to the roller axis. The roller is not shown, although the representation of the carrier stock of apertured plastics film is shown having an arcuate profile due to use of a roller and will be discussed in greater detail with respect to machinery below.

As the roller continues to move, with reference to FIGS. 6d & 6e the side edges 123 & 125 of the aperture diverge elastically to surround the sides of the container beading 126. It will be appreciated that this figure is part cross-section in the plane of the beading 126 and part side-perspective view of the container 122. The application forces AF, acting from a centre of the application roller, are relatively gentle and there are no forces which stretch the plastics sheet material 110 beyond its elastic limit. FIGS. 6f and 6g show corresponding plan and side view of the application process as the edge 127 is received by the rim 126 of the container 122. As illustrated, the application roller is shown as the container passes below the axis of the roller.

FIG. 7 shows a side view of part of a container unitising packaging plant, including a conveyor surface for the transport of containers illustrated here in the form of soft-drinks cans 139 or similar. Typically, the cans 139 would be fed along a conveyor to an accumulation position and automatically gathered together in close proximity in preparation for the application of the apertured plastics film by roller 132. Carrier stock providing the basis for the apertured plastics film 110 is fed from supply system 133. At a convenient position, the carrier stock is cut to provide the necessary apertures for receiving the containers. Reference may be made to GB 2 475 622 B and GB 2 485 895 B for further information on the formation of apertured plastics film and application to containers in a unitising operation. As compared with the unitising machinery illustrated in FIG. 13b of GB 2 475 622 B, it is evident that the carrier stock is further manipulated before application to items as disclosed there.

As illustrated in FIG. 8, the apertured plastics film 110 is covered before delivery for unitising containers with an applied cover material 120, which may be a plastics laminate, for example a polyethylene laminate. The cover material 120 covers the apertures completely and is attached by bonding to the apertured plastics film 110.

FIG. 9 shows in an enlarged view that part of FIG. 7 circled in dashed outline, representing processing of the covered apertured plastics film between rollers 145, and 150, respectively provided with passive formers for manipulating the cover material 120 only by cooperation through the apertures of the apertured plastics film 110 without impacting upon the apertures thereof.

In this embodiment of the method, the cover material 120 is formed into a recessed pouch covering each aperture by inserting a male former 151 into the aperture to contact and deform the cover material 120 locally at the aperture to leave an indentation or semi-collapsed “bubble” after the former male 151 is withdrawn. The former may be a male former which is conveniently passively mounted upon roller 150, and counter roller 145 which aids positioning and transit of the carrier stock, may have a corresponding space or female form adapted to receive the male form.

Referring to FIG. 9, the effect of the transit of the covered apertured plastics film over the roller 150 is to bring passive male former 151 into contact with the cover material 120 of the covered apertured plastics film through an aperture to deform the cover material locally over the aperture, to form an expanded portion, whilst leaving the apertured plastics film 110 unaffected. A corresponding guide roller 145 cooperates with the roller 150 to facilitate advancement of the covered apertured plastics film, and may have either an aperture or female former 146 to facilitate an indentation or recessed pouch being formed in the cover material 120 in a regular controlled manner. Continuing transit of the covered apertured plastics film away from the rollers 145, 150 removes the contact of the cover material with the male former 151 allowing the deformed part of the cover material to relax as a partially collapsed “bubble” over the aperture.

In embodiments of the unitising packaging method, the covered apertured plastics film may be presented to gathered containers for the purpose of forming unitised packages of containers such that with respect to a first container, the cover material 120 is between the container and the apertured plastics film 110, i.e. the latter is uppermost. In embodiments adopting cover materials of greater thickness, say greater than about 50 microns, it may be appropriate to present the covered apertured plastics film with the cover material 120 uppermost such that with respect to a first container the apertured plastics film 110 is between the container and the cover material 120. In either case, the application method using the roller device is the same, and the retention of respective ones of the gathered containers in respective apertures of the apertured plastics film is also the same.

The apertured plastics film for holding containers together to form a unitised carrier package by the disclosed method includes apertures for respectively holding a single container wherein internal edge portions of each aperture form tab elements for contacting the container when positioned within an aperture, and engaging with a beading of the container, and has a plastics cover sheet applied to the apertured plastics film and covering the apertures, wherein the plastics cover sheet is attached to the apertured plastics film at least at edge portions of the apertured plastics film and/or edges of the apertures, and wherein a portion of the cover material is deformed locally at each aperture to effect localised expansion by a former before the apertured plastics film is applied to the containers.

1. A method of forming a carrier for unitising items comprising:
providing a plastics film, forming apertures in the plastics film to provide an apertured plastics film, whereby a plurality of apertures are provided for respectively holding an item, each one of the plurality of apertures being defined between internal edge portions of the plastics film, each edge portion forming a tab for contacting an item when the item is positioned within the aperture, and applying a cover material upon the apertured plastics film to cover the plurality of apertures, and attaching the cover material to the apertured plastics film.

2. A method as claimed in claim 1, wherein the cover material is deformed locally at each aperture by contacting the cover material with a former after attaching of the cover material to the apertured plastics film.

3. A method as claimed in claim 2, wherein the former is provided upon a roller, and the apertured plastics film is brought into contact with a surface of the roller, such that the position of the former coincides with an aperture of the apertured plastics film to effect localised expansion of the cover material.

4. A method as claimed in claim 1, wherein the cover material is attached at edges of the apertured plastics film.

5. A method as claimed in claim 1, wherein the cover material is attached at edges of the respective apertures of the apertured plastics film.

6. A method as claimed in claim 1, wherein the cover material is attached at edges of the apertured plastics film and at edges of the respective apertures of the apertured plastics film.

7. A method as claimed in claim 1, wherein the cover material is attached to the apertured plastics film by bonding the cover material to the apertured plastics film.

8. A method as claimed in claim 1 wherein the cover material is attached to the apertured plastics film by the application of heat or pressure.

9. A method as claimed in claim 1, wherein the cover material comprises a plastics film which is thinner than the apertured plastics film.

10. A plastics film carrier for unitising items comprising (i) an apertured plastics film including one or more apertures arranged for receiving and holding items, and (ii) a plastics cover sheet applied to the apertured plastics film and covering the apertures, wherein the plastics cover sheet is attached to the apertured plastics film at least at edge portions of the apertured plastics film.

11. The plastics film carrier as claimed in claim 10, wherein the plastics cover sheet is a laminated plastics sheet.

12. The plastics film carrier as claimed in claim 10, wherein the plastics cover sheet is at least about 10 microns thick.

13. A plastics film carrier as claimed in claim 10, wherein the apertured plastics film comprises a plurality of apertures, each one of the plurality of apertures being defined between internal edge portions of the apertured plastics film, each edge portion forming a tab for contacting an item when the item is positioned within an aperture.

14. A packaging method for a plurality of items, wherein the items are delivered to a unitising packaging machine, collected and arranged to receive a plastics film carrier as claimed in claim 10 in a unitising operation, wherein the plastics film carrier is applied to the items using a roller.

15. A packaging method as claimed in claim 14, wherein a carrier stock of plastics film is fed to a cutting station operatively associated with the unitising packaging machine, where an apertured profile is formed in the plastics film to provide an apertured plastics film, and subsequently the apertured plastics film is presented for receiving a cover material which is applied to the apertured plastics film and attached thereto to form a covered apertured plastics film for use as a plastics film carrier.

16. A packaging method as claimed in claim 15, wherein the covered apertured plastics film is presented to a device including a former for locally expanding a portion of the cover material associated with an aperture.
